(19) United States
(12) Patent Application Publication
(10) Pub. No.: US 2009/0047469 A1
(43) Pub. Date: Feb. 19, 2009

(54) DEVICE AND METHOD FOR INDICATING PATRON USAGE OF A DRINK AND/OR SEAT

(76) Inventors: Daniel Lane, Los Angeles, CA (US); Eric Tecosky, Los Angeles, CA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/577,457

(22) PCT Filed: Sep. 27, 2005
(86) PCT No.: PCT/US05/34520

§ 371 Date: Jun. 5, 2007

Related U.S. Application Data
(60) Provisional application No. 60/622,202, filed on Oct. 26, 2004.

(51) Int. Cl. B32B 3/10; G09F 3/00

(52) U.S. Cl. 428/131; 40/307

(57) ABSTRACT

A device and method of use with a vessel, e.g., glass or bottle, holding a drink to indicate that the person to whom the drink belongs has not abandoned it and/or his/her seat and/or to protect the drink. The device is a thin member that is generally planar or arranged to be generally planar and is arranged to be disposed on and supported by at least portions of the rim of the vessel to cover the drink. The device has an opening extending through it adapted to enable an item associated with the drink, e.g., a toothpick with an olive on it, a straw, etc., to be extended through the opening into the vessel. The planar member bears indicia indicating usage of the drink/seat to be readily visible when it is in place on the vessel.

### BACKGROUND OF THE INVENTION

1. Field of Invention

This invention relates generally to marking devices and more particularly to a device and method for indicating that a patron in a dining or drinking establishment has not abandoned his/her drink and/or seat.

2. Description of Related Art

In various areas of the country, no-smoking laws have been enacted precluding smoking in public facilities. This can present a problem to patrons of bars or restaurants, who wish to go outside to smoke, since it may require that they temporarily leave their drink unattended at the bar, whereupon the bartender may take it away or another patron take the seat thinking that the person leaving the drink has left the premises permanently. This problem also exists even for non-smoking patrons, e.g., if the patron leaves his her seat to go to the restroom, others can believe that the drink has been abandoned and the seat is vacant.

Currently, patrons of bars and restaurants resort to placing a bar napkin on their drink or beer to signify that their seat is taken. This process creates a messy and unsightly bar area. Also, many people do not understand what the napkin represents. Because of the napkin's light weight, it is very common for the napkin to fall from its place on a glass or bottle negating its function.

The subject invention addresses the forgoing problems by providing a device in the form of a generally planar panel that can be disposed on the glass, mug, bottle or whatever vessel is holding the drink to advise those seeing the device on the vessel that the drink/seat has not been abandoned.

Panel or card-like devices have been disclosed for use on bottles for advertising or other purposes. For example, in U.S. Pat. No. 3,797,658 (Peacock) there is disclosed a card package for use on a soft drink panel to hang and carry a premium item, e.g., golf tees. However, such prior devices are not configured or suited to serve the purpose of the subject invention.

### BRIEF SUMMARY OF THE INVENTION

A device for use with a vessel, e.g., a glass, mug, etc., holding a drink, e.g., an alcoholic beverage, soft drink, water, etc., to indicate that the person to whom the drink belongs has not abandoned it and/or his/her seat. The vessel has a hollow section in which the drink is located and peripheral rim extending about the hollow section.

The device comprises a body member in the form of a thin member that is generally planar or adapted to be generally planar and is of any suitable shape, e.g., a square, rectangular, circular. The body member has at least one major axis. The length of the body member measured along the major axis is greater than the distance separating diametrically opposed portions of the peripheral rim of the vessel, whereupon the body member can be disposed on and supported by at least portions of the rim of the vessel to cover the drink within the vessel. The body member has an opening extending therethrough adapted to enable an item associated with the drink, e.g., a straw, stirrer, toothpick with an olive on it, etc., to be extended through the opening into the hollow section of the vessel. The body member also bears indicia thereon indicating that the person has not abandoned the drink and/or his/her seat. That indicia is positioned so that it is readily visible when the device is in place on the vessel.

In accordance with one preferred aspect of this invention the device is formed of paperboard or other somewhat rigid materials, so that the device can also be used as a coaster. In accordance with another preferred aspect of this invention the device is formed of paper, e.g., paper like that used in napkins, so that the device can also be used as a napkin.

The invention also entails the method of using a device with or without an opening therein, but with the visible indicia thereon to not only warn or notify others that the drink and/or seat has not been abandoned but also to deter anyone from tampering with the drink by placing something foreign into it.

### BRIEF DESCRIPTION OF SEVERAL VIEWS OF THE DRAWINGS

FIG. 1 is a perspective view of one exemplary embodiment of the device of this invention being shown in use on a conventional martini glass;

FIG. 2 is a top plan view of the device of FIG. 1;

FIG. 3 is a perspective view of the device shown in FIGS. 1 and 2, but located on a whiskey glass;

FIG. 4 is a view similar to FIG. 1, but showing an alternative embodiment of the device of this invention located on a martini glass;

FIG. 5 is a plan view of the embodiment of the invention shown in FIG. 4; and

FIG. 6 is a perspective view showing the embodiment of the invention of FIGS. 4 and 5 located on a beer bottle.

### DETAILED DESCRIPTION OF THE PREFERRED EMBODIMENT

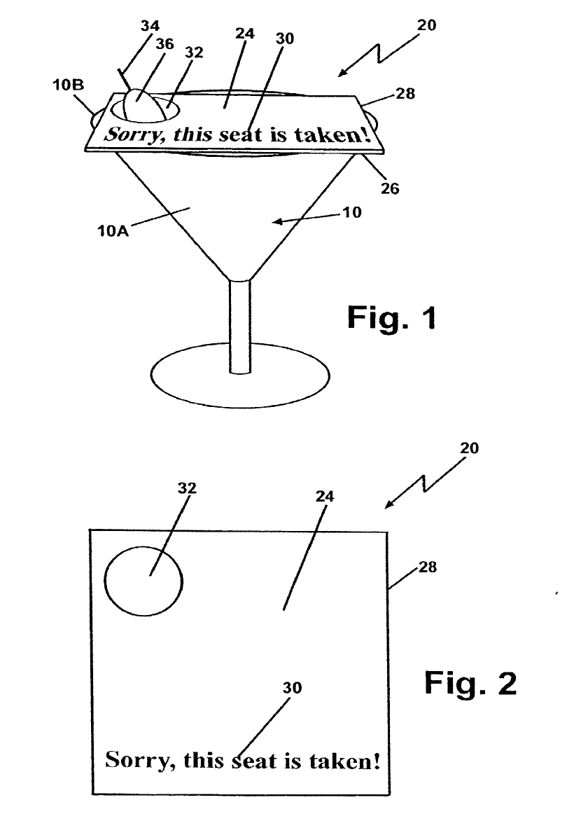

Referring now to the various figures of the drawing wherein like reference characters refer to like parts, there is shown at 20 in FIG. 1a device constructed in accordance with one exemplary embodiment of this invention for use on a glass or other drinking vessel to indicate that the person to whom the drink belongs has not abandoned it and/or his/her seat. In the exemplary embodiment shown in FIG. 1, the drink is in a martini-type glass 10. The martini-glass includes a hollow interior 10A in which the drink is located. The glass terminates at its upper edge in a rim 10B. The device 20 is arranged to be disposed on the rim 10B of the glass to cover at least a substantial portion of the hollow interior of the glass. By so doing the interior of the glass is isolated, thereby deterring a passer-by from surreptitiously introducing some substance, e.g., a drug, into the drink. More importantly, the location of the device on the rim of the glass, will provide a warning or indication to those in proximity to the glass that the drink and/or the patron's seat has not been abandoned.

The device 20 is best seen in FIGS. 1 and 2 and basically comprises a thin, e.g., approximately 1 mm or less, generally planar member (or a flexible member adapted to assume a generally planar shape when disposed on a planar surface—as will be described later). The device may be of any desired peripheral shape. In the exemplary embodiment of FIG. 1, the planar member 20 is of rectangular shape. The planar member 20 includes a top surface 24 and a bottom surface 26. The bottom surface 26 is arranged to be located on the rim 10B of the glass 10. The size of the planar member is sufficiently large so that portions of its bottom surface 26 contiguous with its periphery 28 overlie diametrically disposed portions of the rim 10B, to thereby support the planar member 20 in place over the hollow interior of the glass 10, like shown in FIG. 1.

The top surface 24 of the planar member 20 includes indicia 30 printed or otherwise disposed thereon to be visible when the planar member is in place. That indicia can be any type of warning or message indicating non-abandonment of the drink and/or patron's seat. In the exemplary embodiment shown the indicia is in the form of a notice “Sorry, this seat is taken!”, “Be Right Back.”, etc. Other warnings or messages can be used, depending upon the circumstances. Moreover, the message or warning may be tied in with some advertising or promotional program. For example, the planar member may bear the indicia 30 stating “This is ABSOLUTly my seat!” and may include other indicia advertising Absolut® vodka. Another example may be indicia saying “Jack, this seat is taken!” and also include other indicia advertising Jack Daniel's® whiskey or the name of a restaurant or bar.

It should be pointed out at this juncture that the device may be reversible, so that each side bears the same (or different indicia), whereupon either side of the device can be oriented upward when in place on the vessel. Thus, as used herein the terms top surface and bottom surface are meant to denote which surface is disposed upward when the device is in place on the vessel.

The planar member 20 of this invention also include an opening 32 therein. For example, as shown in FIG. 1, an opening 32 is located in the planar member 20 adjacent one of its corners. That opening can be circular, oval, square or any other desired shape and is provided to enable an item which is associated with the drink to be extended therethrough. For example, as shown in FIG. 1 the opening 32 has a toothpick 34 with an olive or onion 36 thereon extending therethrough into the drink. Thus, the device of this invention will not interfere with the normal organization of the drink.

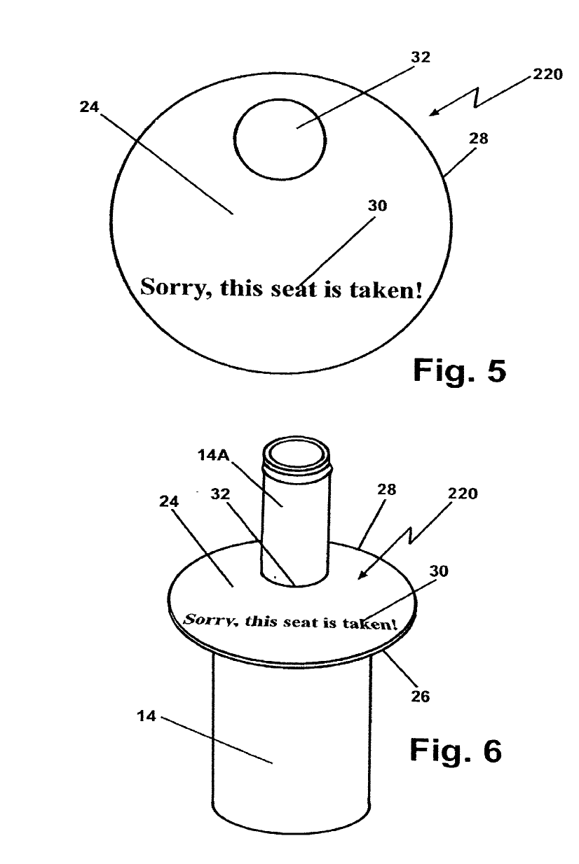

It should be pointed out at this juncture that while the opening 32 for receipt of an implement or edible item has been shown located slightly inward of the periphery of the planar member 20, the opening can be in other locations. For example, the opening 32 may form a notch or recess in the periphery of the planar member, e.g., to accommodate a lemon, lime, orange or other fruit slice disposed on the rim of the glass 10. It is also contemplated that the opening be centrally located, e.g., for use on a beer bottle as an alternative to the device shown in FIGS. 5 and 6. If desired the device may have indicia located adjacent the opening to provide instructions to the user, e.g., the indicia may have arrows pointing to the opening and stating “Straw/Beer Bottle/Olive Pick” to indicate that a straw, the neck of a beer bottle or an olive pick can be inserted through the opening.

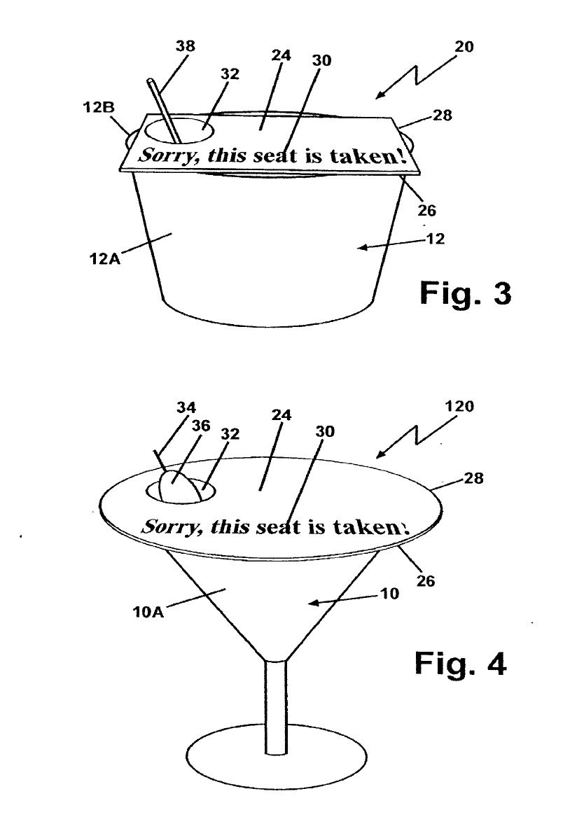

In FIG. 3 there is shown the device of FIG. 1, but used with a conventional whiskey-type glass 12, having a hollow interior portion 12A and a rim 12B. In this exemplary embodiment the device 20 is located on the rim 12B, with a straw 38 extending through the opening 32.

In FIG. 4 there is shown an alternative embodiment of a device 120 constructed in accordance with this invention. That device 120 is similar in construction as the device 20, except that its periphery is round. In the interest of brevity the similar components of the devices 20 and 120 are given the same reference numbers and the details of their construction and organization will not be reiterated. In this embodiment the diameter of the planar member 20 is greater than the diameter of the rim (not shown) of the martini glass 10 so that it completely covers the interior of the glass, except for the opening 32.

In FIGS. 5 and 6 there is shown still another exemplary embodiment 220 of this invention. The device 220 is similar in construction as the device 120, except that its opening is located above the center of the indicia 30, instead of being offset to the side as in the embodiment 120 of FIG. 4. In the interest of brevity the similar components of the devices 120 and 220 are given the same reference numbers and the details of their construction and organization will not be reiterated. The embodiment 220 is particularly adapted for use on the neck 14A of a beer, soft drink or water bottle 14, such as shown in FIG. 6.

As should be appreciated from the foregoing, the devices of this invention are unique, multi-purpose items for use in bars, restaurants, nightclubs, corporate events, etc.

The devices are made out of a flat, thin cardboard material (pulp board) or any other suitable material, e.g., plastic, and can be provided in a variety of shapes and sizes—square, round, oval, triangle, etc. Moreover, while embodiments of the invention made of such materials will be generally rigid or self supporting, such a rigid construction is not mandatory. To that end, the devices of this invention can be made out of a flexible material providing that when such a device is disposed on a generally planar surface it will assume a generally planar configuration. For example, devices constructed in accordance with this invention may be made of paper, e.g., paper like used in conventional folded or unfold paper beverage napkins (not shown). In such a case, when the device is used on a vessel, e.g., a glass, containing a beverage the portion of the device engaging the rim of the vessel will assume a generally planar state, since the rim of the vessel will lie in a plane supporting the device. While there may be some slight sag in the middle of the device over the interior of the vessel, with the amount of sag being a function of the amount of flexibility of the material making up the device, such a sag should be minimal and should not interfere with the drink held within the vessel.

Since the devices of this invention are planar (or are constructed of a flexible material that when disposed on a planar surface become planar), they can also be used as a traditional coaster. Thus, bartenders and customers can place the device on the bar top or table top and then place the drink glass or bottle with the beverage therein on the device, whereupon the device serves as a buffer between the drink glass/bottle and the bar/table top. When devices of this invention are constructed of a flexible material, e.g., paper like that used in napkins, they can also be used as a traditional napkin when not in place on the rim of the vessel. Thus, the devices of this invention offer various desirable features, enabling their use in a wide range of applications.

With a device constructed in accordance with this invention in place on the glass or other vessel in which the patron's drink is located, when the patron gets up from his/her seat and plans on returning, all he/she has to do is to place the device atop their glass/bottle. The indicia bearing the phrase or a form of the phrase, “Sorry, this seat is taken” or “Be Right Back” is clearly displayed on the device for all to see.

The hole in the device makes for ease of use for any type drinking vessel. For example, if the device is placed on top of a collins glass, the straw fits through the hole, allowing for the device to lay flat. The same is true for any glass (rocks, bucket, etc.). On a martini glass, the hole permits room for an olive/onion pick. When the device incorporates a round hole, it can be used fit over the neck of a beer, soda or bottled water.

The devices of this invention are more timely than ever because of the following reasons. In many states (and more to come) smoking is prohibited in bars, restaurants, nightclubs, etc. Patrons find themselves having to leave their spot at the bar or bar table to go outside to smoke. Almost everyone has become increasingly reliant on their cell phone. In a loud environment, many people go outside or to a quiet location to take or make a call, again leaving their seat unattended. Because of the above, the devices of this invention are the answer for the growing concerns of patrons losing their place at the bar or table.

The flat top surface of the devices of this invention, in addition to providing the location of the seat-being used message, can also be used for a variety of advertising and/or promotions for products and/or services. For example, liquor, beer, tobacco, etc. companies may have the opportunity to purchase devices constructed in accordance with this invention as a promotional tool. Thus, on the surface of the those devices, a company can display its logos, catch phrases, new products, etc. Moreover, individual or chain restaurants, bars, nightclubs, etc. can display their establishment's name, logo, specials, etc. on the surface of the devices of this invention. Corporations and small businesses can special order devices of this invention for use in promotion of local events, conventions, etc.

With the growing number of instances where “roofies” or other drugs are dropped into patrons' drinks without their knowledge, the devices of this invention can help guard against such an occurrence. In this regard, having a device constructed in accordance with this invention covering the opening to an unattended drink, can deter people from putting some foreign object into the drink.

Without further elaboration the foregoing will so fully illustrate our invention that others may, by applying current or future knowledge, readily adapt the same for use under various conditions of service.

1. A device for use with a vessel holding a drink to indicate that the person to whom the drink belongs has not abandoned it and/or his/her seat, the vessel having a hollow section in which the drink is located and peripheral rim extending about the hollow section, said device comprising a body in the form of a thin member that is generally planar or adapted to be generally planar, said body member having at least one major axis, with the length of said body member measured along said major axis being greater than the distance separating diametrically opposed portions of the peripheral rim of the vessel, whereupon said body member can be disposed on and supported by at least portions of the rim of the vessel to cover the drink within the vessel, said body member having an opening extending therethrough adapted to enable an item associated with the drink to be extended through said opening into the hollow section of the vessel, said body member bearing indicia thereon indicating that the person has not abandoned the drink and/or his/her seat, said indicia being readily visible when said device is in place on the vessel.

2. The device of claim 1 wherein said body member has at least one corner and wherein said opening is located in said at least one corner.

3. The device of claim 2 wherein said body member is either square or rectangular.

4. The device of claim 1 wherein said body member has a curved periphery and wherein said opening is located closely adjacent said periphery.

5. The device of claim 4 wherein said body member is circular.

6. The device of claim 1 wherein said device is formed of pulp board or cardboard.

7. The device of claim 1 wherein said device is formed of plastic.

8. The device of claim 1 wherein said device is formed of paper.

9. The device of claim 1 wherein said indicia bears text indicating that the drink and/or person's seat has not been abandoned.

10. The device of claim 9 wherein said indicia also includes advertising or promotional material.

11. The device of claim 1 wherein said device is also suitable for use as a coaster for a drink.

12. The device of claim 1 wherein said device is also suitable for use as a napkin.

13. A method of indicating that a person to whom a drink belongs has not abandoned the drink and/or the person's seat, the drink being held within a vessel, said vessel having a hollow section in which said drink is located and a peripheral rim extending about said hollow section, said method comprising:
(A) providing a device comprising a thin, body member that is generally planar or adapted to be generally planar, said body member having at least one major axis, with the length of said body member measured along said major axis being greater than the distance separating diametrically opposed portions of the peripheral rim of said vessel, said planar member including indicia indicating that the person has not abandoned the drink and/or his/her seat; and
(B) disposing said body member on said vessel, so that said body member is supported by at least portions of the rim of said vessel to cover said drink within said vessel.

14. The method of claim 13 wherein the disposition of the device on the rim of the vessel serves to deter anyone from tampering with the drink by inserting something therein.

15. The method of claim 13 wherein said device includes advertising or promotional material for a product or service to encourage persons viewing said device to purchase the product or service.

16. The method of claim 13 wherein said device can be used as a coaster to support said vessel when not used on said vessel.

17. The method of claim 13 wherein said body member has an opening extending therethrough, and wherein said method comprises extending an item associated with said drink through said opening into said hollow section of said vessel.

18. The method of claim 17 wherein the disposition of the device on the rim of the vessel serves to deter anyone from tampering with the drink by inserting something therein.

19. The method of claim 17 wherein said device includes advertising or promotional material for a product or service to encourage persons viewing said device to purchase the product or service.

20. The method of claim 17 wherein said device can be used as a coaster to support said vessel when not used on said vessel.

21. The method of claim 17 wherein said device can be used as a napkin when not used on said vessel.

22. In combination a coaster for a beverage vessel and a device for use with a beverage vessel holding a drink to indicate that the person to whom the drink belongs has not abandoned it and/or his/her seat, the vessel having a hollow section in which the drink is located and peripheral rim extending about the hollow section, said device comprising a body in the form of a thin member that is generally planar, said body member having at least one major axis, with the length of said body member measured along said major axis being greater than the distance separating diametrically opposed portions of the peripheral rim of the vessel, whereupon said body member can be disposed on and supported by at least portions of the rim of the vessel to cover the drink within the vessel, said body member having an opening sufficiently large to accommodate the next of a beer bottle or the like extending therethrough and being adapted to enable an item associated with the drink to be extended through said opening into the hollow section of the vessel, said body member bearing indicia thereon that is readily visible when said device is in place on the vessel.
